(19) United States
(12) Patent Application Publication
(10) Pub. No.: US 2006/0015211 A1
(43) Pub. Date: Jan. 19, 2006

(54) Method and device for processing a moving production part, particularly a vehicle body

(76) Inventors: Thomas Kolb, Holzheim (DE); Helmut Kraus, Hildrizhausen (DE); Thomas Stahs, Ulm (DE)

Correspondence Address: Davidson Davidson & Kappel, 14th Floor, 485 Seventh Avenue, New York, NY, 10018, US

(21) Appl. No.: 10/527,735

(22) PCT Filed: Sep. 6, 2003
(86) PCT No.: PCT/EP03/09914

§ 371 Date: Aug. 29, 2005

(30) Foreign Application Priority Data
Sep. 13, 2002 (DE) 102 42 710.0

(51) Int. Cl. B62D 65/00

(52) U.S. Cl. 700/213

(57) ABSTRACT

A method for processing a moving workpiece (1), in particular a vehicle body (1) which is moved using of a conveyor belt (10). A processing tool (5) is used which is attached to the hand (12) of a robot (7) and comprises a sensor system (18) which is permanently connected to the processing tool (5) and has at least one sensor (19). During the processing, the processing tool (5) follows the moving workpiece. This following movement is based on a closed-loop control process in which the processing tool (5) is oriented periodically towards reference areas (9) of the moving workpiece (1) using measured data of the sensor system (18). The measured data of the sensor system (18) is compared with setpoint data which is generated within the scope of a set up phase (I) of the processing tool (5), and a movement vector of the processing tool (5) is calculated from the difference between the measured values and setpoint data using a Jacobi matrix calculated within the scope of the set up phase, the processing tool (5) being moved by an amount equal to said movement vector. This process is repeated in a control loop.

The invention relates to a method for processing a moving workpiece, in particular a vehicle body which is moved by means of a conveyor belt, according to the preamble of claim 1, such as is disclosed, for example, in DE 195 20 582 C1. Furthermore, the invention relates to a processing system for carrying out this method.

In the large-scale series production of motor vehicles, in particular in the (final) assembly, continuously moving conveyor belts on which vehicle bodies are fed to successive processing and assembly stations are frequently used. At these processing and assembly stations, the vehicle bodies are typically removed from the conveyor belt and moved into clocked stations so that the actual processing and assembly operations can be carried out on a fixed vehicle body. Each junction between the continuously conveying means and a clocked station requires acceleration sections and, under certain circumstances, buffers, which requires an increased amount of space. Furthermore, it is very costly to integrate the processing or assembly station which can be automated into an existing, continuously feeding assembly line because this requires the conveyor belt to be divided.

For this reason there is a keen interest in carrying out automated (i.e. robot-guided) processing and assembly operations directly on the moving object. However, this often involves the difficulty that a processing or assembly robot which is used in such a context has to be coupled to the forward feed movement of the conveyor belt in order to synchronize the robot-guide as a processing or mounting tool with the moving vehicle body. The greater the precision requirements made of the processing and assembly operations the greater the precision required of this coupling.

Such a synchronization may be achieved, for example, by mechanically coupling the processing or assembly robot to the conveyor belt. U.S. Pat. No. 3,283,918 discloses an assembly system in which the robot is made to follow the assembly belt in synchronism with the belt as the programmed work is carried out using a mechanical device. In order to bring about synchronous running between the industrial robot and the workpiece, in each case a laterally protruding driving pin, to which the industrial robot is coupled, is arranged on each of the actual workpieces moved on the conveyor belt or on a workpiece carrier. It is a disadvantage here that despite the synchronous running on both sides, which is brought about by the mechanical coupling between the industrial robot and the workpiece, relative movement still always occurres between the industrial robot and the workpiece and these prevent a precise working operation. These inaccuracies add up to relative movement offsets which exceed the positional correspondence which is necessary or tolerable for a mechanized joining, processing or welding operation.

On the other hand, DE 195 20 582 C1, which forms a generic type, discloses an arrangement for synchronizing a robot with an assembly belt by means of closed-loop controlled equipment. In this system, a relative position closed-loop controller with a measuring device which can determine, within a short compensation section, the position of a driver which is carried along by the workpiece, is provided on the assembly robot in this system. As a result, a highly relative precision can be achieved between the assembly robot and the moving workpiece. A disadvantage with this synchronization of the robot with respect to the conveyor belt by means of closed-loop controlled equipment is that position information is acquired from the passing workpiece using a single measurement and said information is then extrapolated using further information (such as speed of the belt and forward feed direction) to the assembly time. In the actual contact situation there is then only indirect position information available, which can lead to increased inaccuracies and, for example, in the case of an unexpected shutdown of the belt, can lead to an increased requirement for synchronization with the surrounding open-loop control system.

The invention is thus based on the object of developing the known method for robot-supported processing of a moving workpiece to the effect that a relative position of a robot-guided processing tool with respect to the moving workpiece, as far as the execution of the actual processing task, can be set and maintained by controlled processing. The invention is also based on the object of proposing a processing system which is suitable for carrying out the method.

The object is achieved according to the invention by means of features of claims 1 and 6.

According to the invention, the robot-guided processing tool is provided with a sensor system which is permanently connected to the processing tool. The processing tool is firstly moved under the control of a robot into what is referred to as a “proximity position” (permanently programmed and independent of the current position of the workpiece in the working space of the robot) with respect to the workpiece. Starting from this proximity position, a closed-loop control process is run through, in the course of which the processing tool is moved into what is referred to as a “working position” in which the processing tool and/or an add-on part which is held in the processing tool is oriented in a precisely positioned fashion with respect to the workpiece. In the course of the closed-loop control process, (actual) measured values of selected reference areas are generated on the workpiece and/or on the add-on part by the sensor system, and these (actual) measured values are compared with (setpoint) measured values which have been generated in a preceding setup phase. The processing tool is then moved by an amount equal to a movement vector (comprising linear movements and/or rotations) which vector is calculated from a difference between the (actual) and (setpoint) measured values using what is referred to as a “Jacobi matrix” (or “sensitivity matrix”). Both the (setpoint) measured values and the Jacobi matrix are determined within the scope of a setup phase, preceding the actual positioning and mounting process, within the scope of which the processing tool is trained to the specific mounting task (i.e. a specific combination of processing tool, sensor system, vehicle body type and type and installation position of the add-on part to be used).

“Processing” is intended to be understood here as referring to any processing, mounting or measuring operations which are to be carried out on the moving object. In particular, the term “processing” is to be understood as comprising any joining processes on the moving object (welding operations in the body shell phase, application of adhesive in the final assembly phase . . . ), mounting processes (installation of windshields, roof modules etc. in the vehicle assembly phase etc.) which are synchronous with the belt and quality assurance measures (measurement and testing equipment using the production cycle) which accompany the processes.

In the course of the closed-loop control process described above, the processing tool is oriented in the desired working position with respect to the moving workpiece. Periodic (re-)orientation of the processing tool with respect to the workpiece is carried out by periodically repeating the closed-loop control process so that the processing tool “follows” the moving workpiece. During this following process in synchronism with the belt, various processing and/or mounting operations can be carried out on the moving workpiece by the processing tool, and at any time during these processing or mounting operations it is possible to ensure that the processing tool is oriented in a precisely positioned fashion with respect to the workpiece.

No (absolute) information about the instantaneous speed of the assembly belt, the position and orientation of the moving workpiece in the working space of the robot etc. is necessary for this purpose. The method according to the invention is in fact based on relative measurements of the sensor system, in the scope of which information (stored in the setup phase) relating to the closed-loop control process is restored, said information corresponding to a set of (setpoint) measured values of the sensor system.

Since no absolute measurements whatsoever are required to carry out the method, the sensors used do not need to be calibrated either. In particular, it is possible to dispense with an internal metric calibration of the sensors since the sensors which are used no longer “measure” but merely react to a monotonous incremental movement of the robot with a monotonous change in its sensor signal. This means, for example, that, when a television camera or CCD camera is used as a sensor, the camera-internal lens distortions do not have to be compensated and that when a triangulation sensor is used, the precise metric calculation of distance values is dispensed with. Furthermore, there is no need for external metric calibration of the sensors. This means that the position of the sensors with respect to the working space of the robot or the coordinate system of the robot's hand does not need to be determined in order to be able to calculate suitable correction movements. The sensors merely have to be attached to the processing tool in such a way that they are at all capable of sensing suitable measured data of the reference areas on the vehicle body and/or of an add-on part in their capture range.

The result of the following of the path of the moving workpiece is also independent of the absolute positioning accuracy of the robot used and the knowledge about the movement sequence of the conveyor belt since possible inaccuracies of the robot and/or changes in the speed of the belt when the working position is periodically moved to or re-adjusted are compensated. Owing to the resulting short error chains it is possible to achieve a very high repetition accuracy when following the path.

The number of degrees of positioning freedom of the processing tool with respect to the moving workpiece which can be compensated with the method according to the invention is freely selectable and only depends on the configuration of the sensor system. The number of sensors used can also be freely selected. The number of sensor information items made available merely has to be equal to or larger than the number of degrees of freedom to be closed-loop controlled. In particular, a relatively large number of sensors can be provided and the redundant sensor information can be used in order, for example, to sense better shaping errors in the workpiece areas under consideration or to improve the accuracy of the positioning process. Finally, sensor information can be used from different, preferably contact-free sources (for example a combination of CCD cameras, optical gap sensors and triangulation distance measuring sensors). As a result, by using suitable sensors it is possible to take into account the measurement results of different quality-related variables (gap dimensions between the workpiece and an add-on part held in the processing workpiece, junction dimensions, depth dimensions). The method according to the invention can be adapted very easily to new problems since only the means for acquiring and conditioning the sensor data has to be adapted but not the closed-loop controlling system core.

Further advantageous embodiments of the invention can be found in the subclaims. The invention is explained in more detail below with reference to an exemplary embodiment which is illustrated in the drawings, in which:

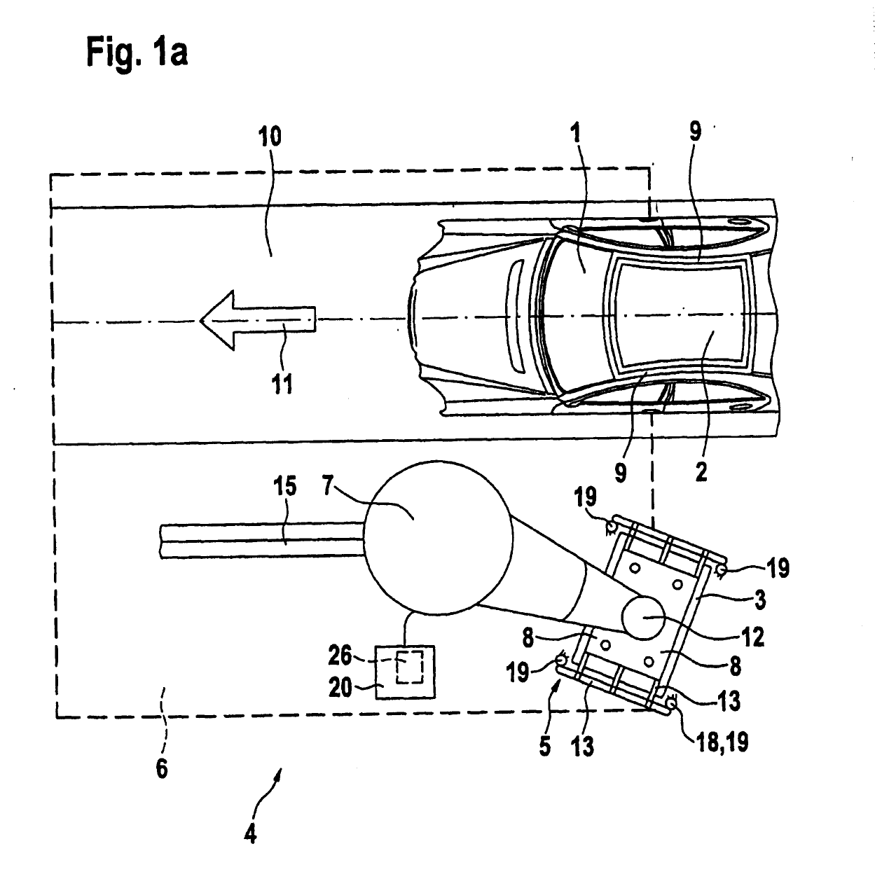

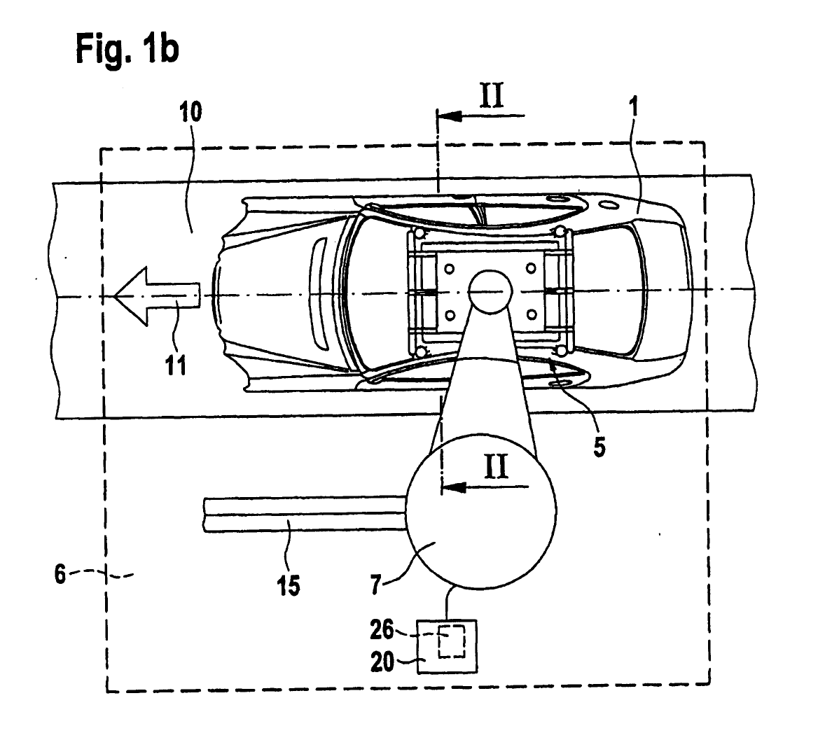

FIG. 1 shows a schematic plan view of a processing system for processing a vehicle body which is moved on a conveyor belt, in different process phases:

FIG. 1a feeding in of the vehicle body,

FIG. 1b processing the vehicle body (bonding of a roof module);

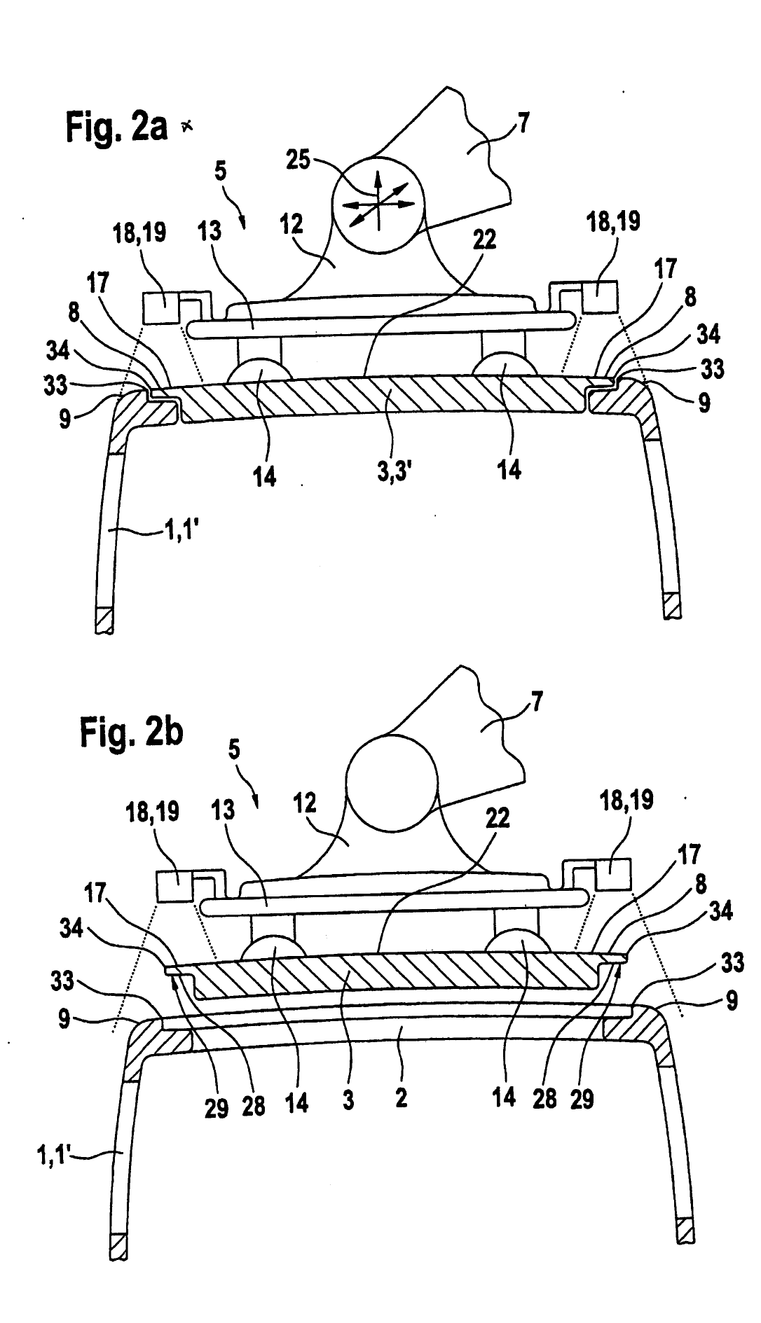

FIG. 2 shows schematic sectional views of the processing system and of the moving vehicle body in FIG. 1 in different process phases:

FIG. 2a: working position of the processing tool with respect to the moving vehicle body;

FIG. 2b: proximity position of the processing tool with respect to the moving vehicle body, and

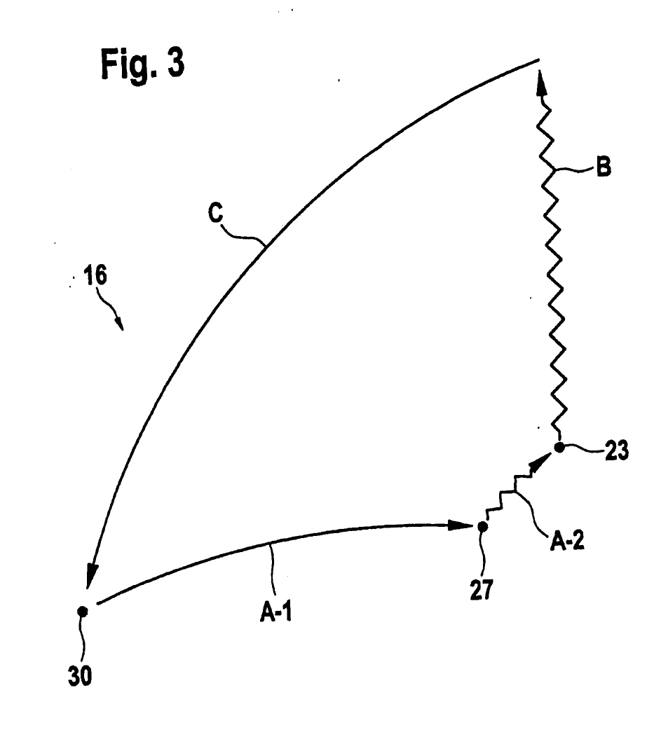

FIG. 3 shows a schematic illustration of the movement path of the processing tool during the execution of mounting steps in FIGS. 1 and 2.

FIG. 1a shows a plan view of a processing system 4 in which roof modules 3 are bonded into roof openings 2 in vehicle bodies 1. Vehicle bodies 1 are fed to the processing system 4 on a conveyor belt 10 and are continuously conveyed on the conveyor belt 10 through the working space 6 of the processing system 4 (direction of arrow 11) during the mounting of the roof module. Each roof module 3 is fed in by a robot 7 and is provided in its edge region with a bonding agent run 29 by means of which the roof module 3 is connected to the roof opening 2 in the vehicle body 1.

In order to be able to mount the roof module 3, by controlled processing, in the vehicle body 1 which is moved on the conveyor belt 10, the roof module 3 must be oriented in a precise positioned fashion (in terms of position and angular attitude) with respect to the roof opening 2 in the moving vehicle body 1, in particular a gap 21 which is provided between the roof module 3 and the adjacent roof areas 9 must have a dimension which is as uniform as possible (see FIG. 2a). The adjacent roof areas 9 form here what is referred to as a reference area for orienting the roof module 3 with respect to the vehicle body 1. This relative orientation between the roof module 3 and roof opening 2 must be retained during the mounting-related process steps, i.e. the roof module 3 must be held with this relative orientation with respect to the roof opening 2 (or pressed onto the roof opening 2) until the bonding agent gels, in order to obtain the desired gap dimension.

The mounting of the roof module 3 in the vehicle body 1 is carried out using a processing tool 5 which is guided by the industrial robot 7 and which places the roof module 3 on the moving vehicle body 1 and positions it precisely with respect to the roof opening 2 in the vehicle body 1. An open-loop control system 20 is provided for controlling the robot 7 and the processing tool 5 in terms of position and movement. The processing tool 5 is attached to the hand 12 of the industrial robot 7 and comprises a frame 13 to which a securing device 14 is attached and by means of which the roof module 3 can be held in a well defined position. In the present exemplary embodiment, the securing device is formed by a plurality of under-pressure suction cups which engage on the upper side 22 of the roof module 3.

In order to measure the position and orientation of the roof module 3, secured in the processing tool 5, with respect to the moving vehicle body 1, the processing tool 5 is provided with a sensor system 18 with a plurality of sensors 19 which are rigidly connected to the frame 13 of the processing tool 5, and they thus form one structural unit with the processing tool 5. The sensors 19 are used to determine join dimensions, gap dimensions and depth dimensions between the reference areas 9 of the roof opening 2 and the adjacent reference areas 17 of the roof module 3. Using this sensor system 18, the roof module 3 which is held in the processing tool 5 is oriented, as described below, with respect to the roof opening 2 in the vehicle body 1 in an iterative closed-loop control process and held in this orientation during the entire mounting process.

If the processing system 5 is to be set to a new processing task, for example to the mounting of a roof module in a new type of vehicle, what is referred to as a setup phase, in which the processing tool 5 is configured, must be firstly run through. In the process, a securing device 14 which is adapted to the roof module 3 to be mounted, a frame 13 which is suitably configured and a sensor system 18 with corresponding sensors 19 are selected and assembled. After this, the sensor system 18 of the processing tool 5 is “trained” by (setpoint) measured values of the sensor system 18 being recorded, as described below in section I, on a “master” vehicle body 1′ which is held in a fixed fashion and a “master” roof module 3′, and by programming the path sections, to be run through in an open-loop controlled fashion, of a movement path 16 of the robot 7. After this setup phase has finished, the processing system 4 which is configured and calibrated in this way is ready for series-production use, during which what is referred to as a working phase is run through for each vehicle body 1 which is fed to a working space 6 of the processing system 4, in which working phase, as described below in section II, an associated roof module 3 is positioned and attached in the roof opening 2 of the vehicle body 1.

I. Setup Phase of the Processing Tool 5:

In order to carry out a new reset processing task, in a first step a sensor system 18 which is adapted to the processing task is firstly selected for the processing tool 5 and attached, together with the securing device 14, to the frame 13. The processing tool 5 which is assembled in this way is attached to the robot's hand 12. The securing device 14 is then equipped with a (“master”) roof module 3′ and oriented (manually or interactively) with respect to a (“master”) vehicle body 1′ secured in a fixed fashion in the working space 6, in such a way that the (“master”) roof module 3′ is oriented in an “optimum” way with respect to the (“master”) vehicle body 1, and this relative position of the (“master”) roof module 3′ with respect to the (“master”) vehicle body 1′ is illustrated in FIG. 2a. Such “optimum” orientation may be defined, for example, by the gap 21 between the (“master”) roof module 3′ and the (“master”) vehicle body 1′ being as uniform as possible, or the gap 21 assuming specific values in specific regions. The relative position which is assumed here by the processing tool 5 with respect to the (“master”) vehicle body 1′ is designated below as “working position” 23.

The number and position of the sensors 19 in the sensor system 18 is selected such that the sensors 19 are directed towards suitable areas 9, 17, particularly important for the “optimum” orientation, of the (“master”) vehicle body 1′ and of the (“master”) roof module 3′. In the exemplary embodiment in FIG. 2a, two optical sensors 19 which measure over an area and which are both directed towards the edges 33, 34, adjacent to one another, of the (“master”) vehicle body 1′ and of the (“master”) roof module 3′ are shown symbolically. The profiles of the edges 33, 34 in the image field of the sensors 19 and the dimensions of the gap 21 are calculated in the evaluation unit 26 from images recorded by the sensors. In addition to these gap measurement sensors, it is possible to provide further sensors which, for example, measure a (depth) distance between (“master”) vehicle body 1′ and (“master”) roof module.

The processing tool 5 with the sensor system 18 and with the (“master”) roof module 3′ held in the securing device 14 is then “trained”, using the robot 7, to the working position 23 (set by means of the manual or interactive orientation and assumed in the illustration in FIG. 2a) with respect to the (“master”) vehicle body 1′. In the process, measured values of all the sensors 19 are firstly recorded in the working position 23 and stored as “setpoint measured values” in an evaluation unit 26 of the sensor system 18, and this sensor evaluation unit 26 is expediently integrated into the control system 20 of the robot 7. Then, starting from the working position 23, the position of the processing tool 5 and of the (“master”) roof module 3′, which is held therein, with respect to the (“master”) vehicle body 1′ is changed systematically along known movement paths, indicated by arrows in FIG. 2a, using the robot 7, and as a rule these are incremental movements of the robot 7 in its degrees of freedom. The changes which occur in the measured values in the sensors 19 in the process are recorded (completely or partially). What is referred to as a “Jacobi matrix” (sensitivity matrix) is calculated from this sensor information in a known fashion, said matrix describing the relationship between the incremental movements of the robot 7 and the changes which occur in the sensor measured values in the process. The method for determining the Jacobi matrix is described, for example, in “A tutorial on visual servo control” by S. Hutchinson, G. Hager and P. Corke, IEEE Transactions on Robotics and Automation 12(5), October 1996, pages 651-670. In this article, there is also a description of the requirements made of the movement paths and the measuring environment (constancy, monotony, . . . ) which have to be fulfilled in order to obtain a valid Jacobi matrix. The incremental movements are selected in such a way that during this setup process collisions cannot occur between the processing tool 5 or the (“master”) roof module 3+ and the (“master”) vehicle body 1′.

The Jacobi matrix which is generated in the setup phase is stored, together with the “setpoint measured values” in the evaluation unit 26 of the sensor system 18, and this data forms the basis for the later positioning process, to be run through in a closed-loop controlled fashion, of the processing tool 5 with respect to the moving vehicle body 1 and the high-precision, closed-loop controlled movement by the working tool 5 as it follows the vehicle body 1 in the working phase (see section II below).

Furthermore, a movement path 16 of the robot's hand 12 (and thus of the processing tool 5) is generated in the setup phase and run through in an open-loop controlled fashion in the later working phase II. This movement path 16 is represented schematically in FIG. 3. The starting point of the movement path 16 is formed by what is referred to as a “return movement position” 30 which is selected such that there is no risk of collisions occurring between the processing tool 5 or the roof module 3 held therein and the vehicle bodies 1 which are moved on the conveyor belt 10. This return movement position 30 may correspond, for example, to an equipping station (not illustrated in the figures) in which the roof module 3 is held by the mounting tool 5 and in which bonding agent runs 29 are applied to selected areas 28 of the underside of the roof module using a bonding agent-applying robot (not shown in FIGS. 1a and 1b), and.

Starting from this return movement position 30, the movement path 16 comprises the following separate sections:
A-1 The processing tool 5 with inserted roof module 3 is moved, on a path A-1 which is to be run through in an open-loop controlled fashion, from the return movement position 30 into a permanently predefined, so-called “proximity position” 27 which is selected such that all the individual sensors 19 of the sensor system 18 can sense valid measured values of the respective area 9, 17 of the roof module 3 and/or of the vehicle body 1, while at the same time it is ensured that collisions between the processing tool 5 or the roof module 3 and the vehicle body 1 cannot occur (see FIG. 2b).
A-2 The processing tool 5 with inserted roof module 3 is moved, on a path A-2 which is to be run through in a closed-loop controlled fashion in the later working phase, from the proximity position 27 into the working position 23 (“trained” as described above) in which the roof module 3 which is held in the processing tool 5 is oriented in a precisely positioned and angled fashion with respect to the roof opening 2 in the vehicle body 1. What happens in particular during this process step to be run through in a closed-loop controlled fashion is described below (in II working phase).
B Now there is the actual processing operation, during which the roof module 3 which is held in the processing tool 5 is pressed into the roof opening 2 with a predefined pressure and held in this position until the bonding agent 29 gels or cures, and during this time the robot 7 periodically runs through a closed-loop control process, as a result of which the processing tool 5 remains oriented in the relative position (found as a result of the closed-loop control process A-2) with respect to the moving vehicle body 1.
C If the mounting process has finished, the control system 20 of the robot 7 outputs the signal which causes the processing tool 5 to stop following the moving vehicle body 1 in an oriented fashion. The processing tool 5 is then moved back under robot control into the return movement position 30.

The movement path 16, generated within the scope of the setup phase, of the processing tool 5 is thus composed of two sections A-1 and C which are to be run through in an open-loop controlled fashion, and two sections A-2 and B which are to be run through in a closed-loop controlled fashion. Steps A-1 and C can be input interactively during the training phase of the processing tool 5 or they can be stored in the form of a program (generated off-line) in the open-loop control system 20 of the robot 7.

II. Working Phase

In the working phase, vehicles bodies 1 are carried sequentially through the working space 6 of the processing system 4 on the conveyor belt 10, and in each of these moving vehicle bodies I a roof module 3, provided with a bonding agent run 29, is positioned precisely with respect to the roof opening 2 by means of the processing system 4 and using the movement path 16 trained in the setup phase I, and said roof module 3 is installed in the moving vehicle body 1 with this relative orientation.

Movement Path Section A-1 (Proximity Phase):

While the new vehicle body 1 is being fed in, the processing tool 5 is in the return movement position 30 and in said position it picks up a roof module 3 which is to be provided with a bonding agent 29 and is to be mounted (see FIG. 1a). As soon as the new vehicle body 1 has been moved into the working space 6 (and has moved through, for example, a photoelectric barrier in the process), the control system 20 of the robot 7 receives a signal which triggers the movement path section A-1. The processing tool 5 with inserted roof module 3 is moved here in an open-loop controlled fashion into the (spatially fixed) proximity position 27 in FIG. 2b which, as mentioned above, has been selected in such a way that the roof opening 2 (or the reference areas 9) of the moving vehicle body 1 are located in the capture area of the sensors 19 of the processing tool 5 irrespective of the precise position of the vehicle body on the conveyor belt 10.

Movement Path Section A-2 (Positioning Phase of the Processing Tool 5):

Starting from this proximity position 27, a positioning phase (path section A-2 in FIG. 3) of the processing tool 5 is run through, in the scope of which the roof module 3 which is held in the processing tool 5 is moved into the working position 23 (trained during the training phase I) with respect to the moving vehicle body 1 and in the process oriented in a precisely positioned fashion with respect to the roof opening 2. For this purpose, measured values are recorded by the sensors 19 of the sensor system 18 in selected areas 9, 17 of the roof module 3 and of the vehicle body 1. A movement increment (movement vector) which reduces the difference between the current (actual) sensor measured values and the (setpoint) sensor measured values is calculated using these measured values and the Jacobi matrix determined in the setup phase. The roof module 3 which is held in the processing tool 5 is then moved and/or pivoted by this movement increment using the robot 7, and new (actual) sensor measured values are recorded during the ongoing movement.

This iterative measuring and movement process is repeated in a control loop until the difference between the current (actual) and the end-at (setpoint) sensor measured values drops below a predefined fault measure, or until this difference no longer changes beyond a threshold value which is specified in advance. The roof module 3 is then in the working position 23 (illustrated in FIG. 2a) with respect to the vehicle body 1 (within the scope of the accuracy predefined by the fault measure or threshold value).

The iterative minimization which is run through in this positioning phase A-2 compensates both inaccuracies in the vehicle body 1 in terms of its position and orientation on the conveyor belt 10 and possibly present shaping errors of the roof opening 2 of the vehicle body 1 (i.e. deviations from the (“master”) vehicle body 1′). At the same time, inaccuracies in the roof module 3 with respect to its position and orientation in the processing tool 5 and possibly present shaping errors of the roof module 3 are compensated (i.e. deviations from the (“master”) roof module 3′). As a result of a periodic repetition of the recording of measured values and of the closed-loop control process, the movement of the vehicle body 1 in the working space 6 of the processor system 4 is furthermore compensated so that the robot-guided processing tool 5 “follows” the vehicle body 1. Such “following” of the vehicle body 1 by the processing tool 5 by controlled processing merely requires changes in the relative position between the vehicle body 1 and the robot 8 to take place more slowly than the measurement and closed-loop control of the position of the sensor system 18 and processing tool 5 (or robot's hand 12).

In the course of this iterative closed-loop control process A-2, the roof module 3 is fitted into the roof opening 2 in the vehicle body 1 in the “optimum” way independently of the movement of the vehicle body 1. In order to detect and evaluate shaping errors of the roof module 3 and of the vehicle body 1 separately, it is possible to provide additional sensors (i.e. not required for the actual positioning task) on the processing tool 5, the measured values of which sensors are used exclusively or partially for sensing the shaping errors. Furthermore the measured values of the individual sensors 19 can be provided with different weighting factors in order to bring about a weighted optimization of the position of the roof module 3 with respect to the roof opening 2 in the vehicle body 1.

An important property of the positioning phase A-2 is its independence from the accuracy of the robot: since the positioning process is based on an iterative comparison between the (actual) measured values and (setpoint) measured values, any positioning inaccuracy of the robot 7 is compensated immediately by the iterative control process.

Operation B (Attachment of the Roof Module 3 to the Vehicle Body 1):

In the working step B which now follows, the roof module 3 is connected to the vehicle body 1. The processing tool 5 follows the moving vehicle body 1 in a closed-loop controlled fashion in that the sensors 19 periodically record, in continuation of the process step A-2, measured values of the areas 9 on the vehicle body 1 in an iterative control loop, and compare said values with the setpoint data stored in the evaluation unit 26, and if differences occur between the setpoint and the actual values—which can be expected with a moving vehicle body 1—the position of the robot's hand 12 is corrected in an analogous way to the closed-loop control process described in A-2 in order to keep these differences as small as possible.

In parallel with this closed-loop controlled following movement of the mounting system 5 by the sensor system 18, the roof module 3 is then held in the desired relative position (corresponding to the working position 23) with respect to the roof opening 2, or pressed with a predefined (or closed-loop controlled) force onto the roof opening 2, using the securing device 14. When the gelling or hardening time of the bonding agent 29 has passed, the roof module 3 is released by the securing device 14.

Depending on the duration of the processing operation to be carried out in this operation B and on the forward feed speed of the conveyor belt 10 it may be expedient not to hold the robot 7 in a fixed way but rather to move it on a rail 15 running parallel to the conveying direction 11 of the belt 10. The path movement of the robot 7 on the rail 15 is a closed-loop controlled movement here and is thus not coupled to the forward feed of the conveyor belt 10. Irrespective of whether or not the robot 7 moves along with the conveyor belt 10, the orientation of the roof module 3 on the moving vehicle body 1 which accompanies the process is therefore carried out exclusively by the iterative closed-loop control process described above, i.e. on the basis of the on-line acquisition and evaluation of measurement data by the sensor system 18. For this reason, there is no need to couple the processing tool 5 to the conveyor belt 10 mechanically and the open-loop control system 20 of the robot 7 does not need to be interconnected to the open-loop control the conveyor belt in any way (electrical/electronic).

During the following phase B, a position control loop is advantageously run through periodically at predefined (as short as possible) time intervals in order to keep the tool 5 continuously oriented with respect to the roof opening 2. If this is not possible (because, for example, the tool 5 briefly has to be moved out of the roof area in order to make this area accessible to further tools), a brief “dry run” can be carried out by the robot's hand 12 during which the estimated forward feed of the vehicle body I is estimated.

Movement Path section C (Return Movement of the Processing Tool 5):

After the mounting of the roof module 3 has finished (see FIG. 1b), the closed-loop controlled following movement, which is described in section B and by means of which the processing tool 5 is coupled to the conveying movement of the vehicle body 1, is aborted. The processing tool 5 is moved back along the movement path C, under the control of the robot, into the return movement position 30 and equipped there with a new roof module 3.

When a new roof module 3 is picked up by the processing tool 5, the sensor system 18 can be used to ensure that the roof module 3 is oriented in a highly precise fashion in the processing tool 5. In this case, the processing system 5 is trained to a “pick-up position” in the course of a setup phase which proceeds in an analogous way to the setup phase described above in section I, said “pick-up” position corresponding to a predefined position/orientation of the processing tool 5 (and thus of the sensors 19 of the sensor system 18) with respect to the roof module 3. The roof module 3 is fed to the processing system 4 in, for example, a workpiece carrier (not illustrated in the figures). A method, which can be automated, for removing a roof module from a workpiece carrier in a precisely positioned fashion is described in (PCT patent application, our file number P803860).

The highly precise orientation of the roof module 3 in the processing tool 5 is recommended in particular if the roof module 3 is moved along in the equipping station (i.e. before the insertion into the moving vehicle body 1 described above) on an open-loop controlled path past a bonding tool (for example a bonding robot) using the processing tool 5, said bonding tool applying the bonding agent run 29 to the desired areas 28 of the roof module 3. In order to bond the roof module 3 in the roof opening 2 by controlled processing it is indispensable to ensure a precise position of the bonding agent run 29 on the roof module 3, and this in turn can be carried out with an acceptable amount of cost only if the roof module 3 is oriented in a highly precise fashion with respect to the bonding tool during the application of the bonding agent, which can be ensured by high precision positioning of the roof module 3 in the mounting tool 5. In this case, in the course of the working phase II during the positioning phase A-2 (and the following phase B), the processing tool 5 must only be oriented with respect to the reference areas 9 of the vehicle body 1, and the position of the reference area 17 of the roof module 3 is known owing to the precisely positioned way in which the roof module 3 is held in the tool 5 so that the features no longer need to be sensed during the working phase II.

Alternatively, the roof module 3 can be held “imprecisely” with respect to its position/orientation (i.e. without highly precise orientation of the tool 5 with respect to the roof module 3) in the processing tool 5. This is recommended, for example, in the cases in which the roof module 3 is already provided with a bonding agent run 29 at the time when it is picked up by the processing tool 5. In this case, in the course of the working phase II during the positioning phase A-2 (and the following phase B), measured data is sensed both by the roof module 3 and by the vehicle body 1 so that the relative position is conveyed. Owing to this relative positioning during the working phase II, the “imprecise” support of the roof module 3 in the tool 5 does not have any influence at all on the positioning accuracy of the roof module 3 in the roof opening 2.

A TCP/IP interface, which permits a high data rate, is advantageously used in the present exemplary embodiment for the purpose of data communication between the different system components (evaluation unit 26 of the sensor system 18 and of the control unit 20 of the robot 7). Such a high data rate is necessary in order to be able to carry out closed-loop control of the entire system (sensor system/robots) with the large number of individual sensors 19 using the interpolation cycle of the robot 7 during the positioning and following phases A-2 and B which are to be run through in a closed-loop controlled fashion.

As well as the mounting of roof modules in vehicle bodies, the method can be transferred to any other processing operations in which a robot-guided processing tool 5 is to be used to process a workpiece 1 with high precision. In particular, the method is suitable for mounting front windshields in moving vehicle bodies. “Robot-guided” processing tools are to be understood in the context of the present application in a quite general way as tools which are mounted on a multi-axle manipulator, in particular a six-axle industrial robot 7.

1-8. (canceled)

9. A method for processing a moving workpiece moved using conveyor belt, a processing system for processing the workpiece having a processing tool attached to a hand of a robot, the processing system including a sensor system fixedly connected to the processing tool, the sensor system including at least one sensor, the method comprising the following steps:
moving, during a positioning phase, the hand with the processing tool into a working position, the processing tool in the working position being oriented in a precisely positioned fashion with respect to a reference area of the workpiece moved on the conveyor belt;
maintaining, during a subsequent processing phase, the processing tool oriented with respect to the reference area on the workpiece;
running through a periodically repeating, iterative closed-loop control process during the positioning phase and the processing phase, the closed-loop control process including:
generating an actual measured value of the reference area of the workpiece by the at least one sensor,
comparing the actual measured value with a setpoint measured value generated during a set up phase,
calculating a movement vector of the hand from a difference between the actual measured value and the setpoint measured value using a Jacobi matrix calculated during the set-up phase, and
moving the processing tool using the movement vector.

10. The method as recited in claim 9 wherein a TCP/IP interface is used for communication between a control system of the robot and an evaluation unit of the sensor system.

11. The method as recited in claim 9 wherein to position the processing tool with respect to different vehicle body types or with respect to different reference areas of a same vehicle body type, the measured values of different individual sensors of the sensor system are used for closed-loop position control.

12. The method as recited in claim 9 wherein the workpiece is a vehicle body.

13. The method as recited in claim 12 wherein the processing tool mounts a roof module in a roof opening in the vehicle body.

14. The method as recited in claim 12 wherein the processing tool mounts a windshield in a front window opening in the vehicle body.

15. A processing system for processing a moving workpiece moved using a conveyor belt, the processing system comprising:
a processing tool attached to a hand of a robot;
a control system for controlling the robot and the processing tool;
a sensor system having at least one sensor fixedly connected to the processing tool; and
an evaluation unit for evaluating measured values of the sensor system;
the at least one sensor, during a positioning and processing phase, being directed toward a reference area of the moving workpiece,
the processing tool capable of being coupled in a contact-free fashion to a path movement of the moving workpiece using measured values of the sensor system.

16. The processing system as recited in claim 15 wherein the at least one sensor is a noncalibrated sensor.

17. The processing system as recited in claim 16 wherein the at least one sensor is an optical sensor measuring over an area.

18. The processing system as recited in claim 15 wherein the at least one sensor is an optical sensor measuring over an area.

19. The processing system as recited in claim 15 wherein the processing system is a vehicle processing system.
